(19) United States
(12) Patent Application Publication
(10) Pub. No.: US 2004/0203884 A1
(43) Pub. Date: Oct. 14, 2004

(54) Method and system for determining location of a mobile communication unit

(76) Inventors: Patti McCalmont, Oswego, IL (US); Robert Allen Sherry, Aurora, IL (US); Mark Nathaniel Drennan, Longmont, CO (US); Edward Schlein, Monument, CO (US); Kuen-Yih Hwang, Naperville, IL (US)

Correspondence Address: LAW OFFICE OF DONALD D. MONDUL, 6631 LOVINGTON DRIVE, DALLAS, TX, 75252, US

(21) Appl. No.: 10/302,283

(22) Filed: Nov. 22, 2002

(51) Int. Cl. H04Q 7/20

(52) U.S. Cl. 455/456.1; 455/457

(57) ABSTRACT

A method for determining location of a mobile unit, whether active or idle, of a plurality of communication units in a telecommunication network including at least one mobile service tower or access point for establishing a wireless communication link with the mobile unit includes the steps of: (A) Posing a location query from an originating calling unit in communication with the network specifying the mobile unit. (B) Selected calling sessions with selected communication units are preceded by a plurality of set-up signals for configuring the network for supporting the calling sessions. Routing at least one set-up signal to the mobile unit in response to the location query to alert the mobile signal of the posing. (C) Sending at least one response signal from the mobile unit to the originating calling unit identifying a respective mobile service tower or access point in wireless communication with the mobile unit.

### BACKGROUND OF THE INVENTION

The present invention is directed to telecommunication networks, and especially to telecommunication networks configured for handling location queries from originating units to determine location of particular mobile units in communication with the network.

The telecommunications industry is presently seeking to develop industry standards to provide a locating capability for determining location of mobile communication units, such as cellular phones, personal digital assistant units or other wireless communication apparatuses. Locating such portable units is difficult when one of the portable units is deployed within its home communication system. The difficulties are significantly increased when a portable communication unit is deployed outside its home communication system, as in the case when such a unit is roaming in another communication system than its home system.

Location of a mobile communication unit is useful to know in several instances, such as when seeking to provide emergency services, or in seeking to market goods or services that are short-lived and geographically sensitive in nature, seeking location information regarding an individual truck in a fleet of trucks, finding a child or in other instances. Examples of such goods or services may include, by way of example and not by way of limitation, sale events occurring at specific stores or in specific regions, advertising for movie show times or movie premier opening events in certain areas, or other events.

Active mobile devices are mobile devices actively engaged in a calling session within the telecommunication network. Idle mobile devices are mobile devices that have “checked in” with a mobile network to establish their presence within the mobile network, but which are not actively engaged in a calling session. Mobile devices commonly effect such a “checking in” with a mobile network (e.g., a cellular telephone network) to establish their presence within the network and periodically transmit or exchange administrative signaling (e.g., routing signals or set up signals) with the mobile network to confirm their presence in the network.

There is a presently extant need for providing at least some location information regarding mobile units, whether active or idle. It would be useful to satisfy that need without awaiting yet-to-be developed and standardized systems and methods, and without significant additional investment in new system equipment or new communicating units.

It would be useful to be able to provide coarse location information at least to mobile site accuracy, such as to cell site accuracy in a cellular telephone system, for active and idle mobile devices without significant additional investment in new system equipment or new communicating units.

### SUMMARY OF THE INVENTION

A method for determining location of a mobile unit of a plurality of communication units in a telecommunication network including at least one mobile service tower or access point for establishing a wireless communication link with the mobile unit includes the steps of: (A) Posing a location query from an originating calling unit in communication with the network specifying the mobile unit. (B) Selected calling sessions with selected communication units are preceded by a plurality of set-up signals for configuring the network for supporting the calling sessions. Routing at least one set-up signal to the mobile unit in response to the location query to alert the mobile signal of the posing. (C) Sending at least one response signal from the mobile unit to the originating calling unit identifying a respective mobile service tower or access point in wireless communication with the mobile unit.

A system for determining geographic location of a particular mobile communication unit of a plurality of communication units in a telecommunication network including at least one mobile service tower or access point for establishing a wireless communication link with the particular mobile communication unit includes: (A) Means for posing from an originating calling unit in communication with the telecommunication network a location query specifying the particular mobile communication unit. Selected calling sessions with selected communication units of the plurality of communication units are preceded by a plurality of set-up signals for configuring the telecommunications network for supporting the selected calling sessions. (B)Means for routing at least one set-up signal of the plurality of set-up signals to the particular mobile communication unit in response to the location query to alert the particular mobile communication signal of the posing. (C) Means for sending at least one response signal from the particular mobile communication unit to the originating calling unit identifying a respective serving mobile service tower or access point of at least one mobile service tower or access point in wireless communication with the particular mobile communication unit.

It is therefore an object of the present invention to provide a method and system for determining location of a mobile communication unit that may be presently employed whether active or idle without significant additional investment in new system equipment or new communicating units.

It is a further object of the present invention to provide a method and system for determining location of a mobile communication unit that can provide coarse location information at least to mobile site accuracy, such as to cell site accuracy in a cellular telephone system.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram illustrating a communication system in which the present invention may be employed.

FIG. 2 is a flow diagram illustrating the method of the present invention.

### DETAILED DESCRIPTION OF THE PREFERRED EMBODIMENT

The preferred embodiment of the present invention uses routing or set-up signals to implement a Location Based Service (LBS) for determining location of a particular mobile communication unit to mobile tower or access point accuracy.

By way of example and not by way of limitation, routing or set-up signals in an IS-41 standard communication system may be embodied in Wireless Intelligent Network (WIN) control signaling or triggers (signals triggering certain events). Another example is in a GSM (Groupe Speciale Mobile, or Global System for Mobile Communications) standard communication system in which routing or set-up signals appropriate for implementing the invention may be embodied in Customized Applications for Mobile network Enhanced Logic (CAMEL) control or trigger signaling.

In its most preferred embodiment, the present invention is embodied in a subscribed-for service that configures routing or set-up signals (e.g., WIN triggers or CAMEL triggers) to effect location of the particular mobile communication unit without completing the call set-up process. The consent of the user of the sought-after mobile communication unit is preferred in order to ensure that privacy of the mobile user is preserved and the mobile user consents to being located. There may be provision for indicating to the user each occasion of a seeking to locate the mobile communication unit, if desired. Otherwise, the process of locating a mobile communication unit may be carried out without indicating each location query to the mobile user.

In practicing the present invention, when a Service Control Point (SCP) in a telecommunication network receives a location query from an originating unit, the SCP will initiate a telephone call to the particular mobile communication unit identified in the location query via a respective Mobile Switching Center (MSC) serving the particular mobile unit. Mobile communication systems are required to keep track of where respective mobile communication units may be found, even when a mobile unit roams away from its home mobile network. Location information is continuously updated and stored in data bases, often referred to as a Home Location Register (HLR) located in the mobile unit's home network, and a Visitor Location Register(VLR) located in the network in which the mobile unit is roaming. These location registers may be updated as mobile units in a network periodically identify themselves to the network via identification signals. The MSC likely involved in maintaining a wireless link with a mobile unit may be ascertained by the SCP using its locally situated Home Location Register (HLR) in cooperation with a Visitor Location Register (VLR) when the mobile unit is roaming outside its home network. Another alternative is to poll all MSCs in a network to ascertain in real time whether a particular mobile unit is in communication with a wireless communication tower or access point that is serviced by a respective MSC. This function described as being handled by the SCP may be carried out by a Mobile Positioning Center (MPC) (in an IS-41 standard system) or a Gateway Mobile Location Center (GMLC) (in a GSM standard system) operating in support of the Location Based Services (LBS) system in cooperation with an SCP. As mentioned earlier, a Location Based Service (LBS) of the sort described herein may be a service to which one would subscribe, and participation in such a service may be acceded to by mobile unit users.

Prior to completing the SCP/MPC/GMLC-originated call to the mobile unit (via a wireless communication tower or access point), the MSC exchanges routing or set-up signals with the mobile unit. Receiving responsive routing or set-up signals by an MSC during such an exchange verifies that the sought-after mobile unit is in wireless communication with the MSC via a respective wireless communication tower or access point. The MSC passes at least a portion of the responsive routing or set-up signals to the SCP/MPC/GMLC to request call handling instructions. When the SCP/MPC/GMLC receives the responsive routing or set-up signals, the SCP/MPC/GMLC uses the serving cell identification code embedded within the responsive routing or set-up signals to verify identification of the wireless communication tower or access point (e.g., cell site or micro cell information) that has responded as handling the wireless link with the particular mobile unit designated in the location query. The wireless communication tower or access point identification information is provided to the originating station, and the SCP/MPC/GMLC answers to the responsive routing or set-up signals with an indication that permits abandoning the call set-up without completing the call to the mobile unit.

Thus, an important aspect of the present invention is that no changes to call handling routing or set-up signals are required. The invention provides that handling of the established routing or set-up signals is altered, not the signals themselves. When call set-up or routing is carried out in response to a location query according to the invention, the call set-up or routing process is truncated at an interim processing juncture. The interim processing juncture occurs before actually completing the call placement process and after desired location information is established in real time.

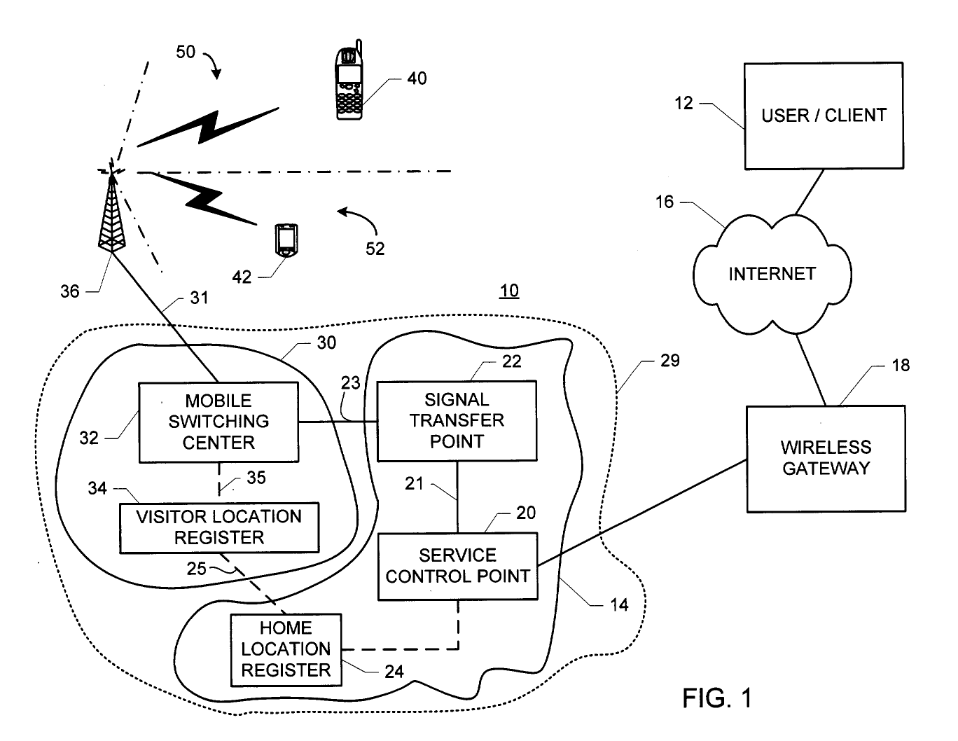

FIG. 1 is a schematic diagram illustrating a communication system in which the present invention may be employed. In FIG. 1, a location based services system 10 includes an originating user, or client communication unit 12 in communication with a telecommunication network 14. In the exemplary system 10 illustrated in FIG. 1, originating user unit 12 communicates with a first telecommunication network 14 via the Internet 16 and a wireless gateway facility or server 18. Other communication access arrangements between originating user unit 12 and telecommunication network 14 may be established within the scope of the present invention. By way of example and not by way of limitation, originating user unit 12 may be connected within first telecommunication network 14.

First telecommunication network 14 includes a service control point (SCP) 20, a signal transfer point (STP) 22 and a Home Location Register (HLR) 24. FIG. 1 is intentionally present as a simplified drawing to facilitate illustrating the present invention. In reality, first telecommunication network 14 may include a plurality of each of service control point (SCP) 20, signal transfer point (STP) 22 and Home Location Register (HLR) 24.

First telecommunication network 14 may establish communications with a second telecommunication network 30. Second telecommunication network 30 may also include a plurality of each of an SCP, an STP and an HLR (none of which are shown in FIG. 1) and further includes a Mobile Switching Center (MSC) 32 and a Visitor Location Register (VLR) 34. MSC 32 is in communication with a plurality of wireless communication towers; a representative wireless communication tower 36 is illustrated in FIG. 1 as maintaining a first wireless communication link with a mobile phone 40 and maintaining a second wireless communication link with a mobile data device 42 (e.g., a wireless communication capable Portable Digital Assistant (PDA) device). Wireless communication tower 36 establishes a plurality of communication sectors 50, 52 for maintaining wireless communication links. In the exemplary representation of the invention illustrated in FIG. 1, mobile phone 40 is situated in communication sector 50 and mobile data device 42 is situated in communication sector 52.

First communication network 14 and second communication network 30 may be included in a single communication network, as indicated by a dotted line 29 in FIG. 1.

A description of call flow in location based services system 10 begins with originating unit 12 generating a location query seeking an identified or specified particular mobile communication unit. The location query is conveyed via the Internet 16 and wireless gateway 18 (for example) to Service Control Point (SCP) 20 in first telecommunication network 14. Thus, originating unit 12 operates as a means for posing a location query to first telecommunication network 14. In the preferred embodiment of the invention wherein the location based service is a subscribed service, an authentication of the location query may be performed to ensure that the location query is originated by a bona fide subscriber to the service. Such an authentication may be effected anywhere during the progress of the location query; authentication may advantageously be performed at wireless gateway 18.

SCP 20 responds to receiving the location query by initiating a phone call to the mobile communication unit identified in the location query. This initiation of a phone call involves sending specified routing or set-up signals to ultimately arrive at the identified mobile unit. Thus, SCP 20 operates as a means for routing at least one set-up or routing signal to the mobile communication unit identified in the location query. Examples of such routing or set-up signals include, but are not limited to, WIN (Wireless Intelligent Network) control signals, CAMEL (Customized Applications for Mobile network Enhanced Logic) control signals, ISUP (Integrated Services digital network User Part) signals or similar signals The phone call from SCP 20, manifested by routing or set-up signals, arrives at signal transfer point (STP) 22 and is forwarded to mobile switching center (MSC) 32 in second telecommunication network 30. The identification of MSC 32 as the particular MSC serving the identified mobile unit is effected by any of several methods, or a combination of methods, including look-up in an appropriate respective Visitor Location Register (VLR) or Home Location Register (HLR) or by polling all MSCs in appropriate networks until one MSC responds with a return message establishing which wireless communication tower is maintaining a wireless link with the identified mobile unit. MSC 32 sends appropriate routing or set-up signals with the identified mobile unit 40. Mobile unit 40 responds with appropriate routing or set-up signals, thereby verifying that mobile unit 40 is wirelessly linked with wireless communication tower 36. Wireless communication tower 36 sends a return message to MSC 32 verifying its wireless link with mobile unit 40 and identifying itself. Alternatively, wireless communication tower 36 may further indicate in its return message that mobile unit is situated in communication sector 50.

MSC 32 passes the return message received from wireless communication tower 36 to SCP 20 via STP 22. SCP 20 passes location information embedded in the return message to originating unit 12 via wireless gateway 18 and the Internet 16, thus advising originating unit 12 that mobile unit 40 is in communicating range of wireless communication tower 36, and is in communication sector 50 at that site. Thus, MSC 32, wireless communication tower 36 or a combination of MSC 32 and wireless communication tower 36 operates as a means for sending at least one response signal from the mobile communication unit identified in the location query to originating unit 12. If desired, location information in the response message received by SCP 20 may be used to access HLR 24, and the information contained in HLR 24 may be provided to originating unit 12. Such location information may be in the form of latitude and longitude information, proprietary map coordinates, a location description with respect to a landmark or other datum or another form of geographical information. SCP 20 thereafter sends a reply message back to MSC 32 directing termination of any further call setting up with mobile unit 40 for that extant calling session.

In general terms, calls are routed through telecommunication networks along solid line paths 21, 23, 31 in FIG. 1. Routing or set-up signals are routed in part along paths 21, 23, 31 and in part along dotted line paths 25, 35 in FIG. 1.

If desired, an indication of a location query and response event may be displayed at mobile unit 40. Alternatively, no indication of a location query needs to be displayed, and the location query and response event may be entirely transparent to the user of mobile unit 40. In still another embodiment of the invention no display of a location query and reply event is displayed, but a record of the event is made that can be accessed by a user of mobile unit 40.

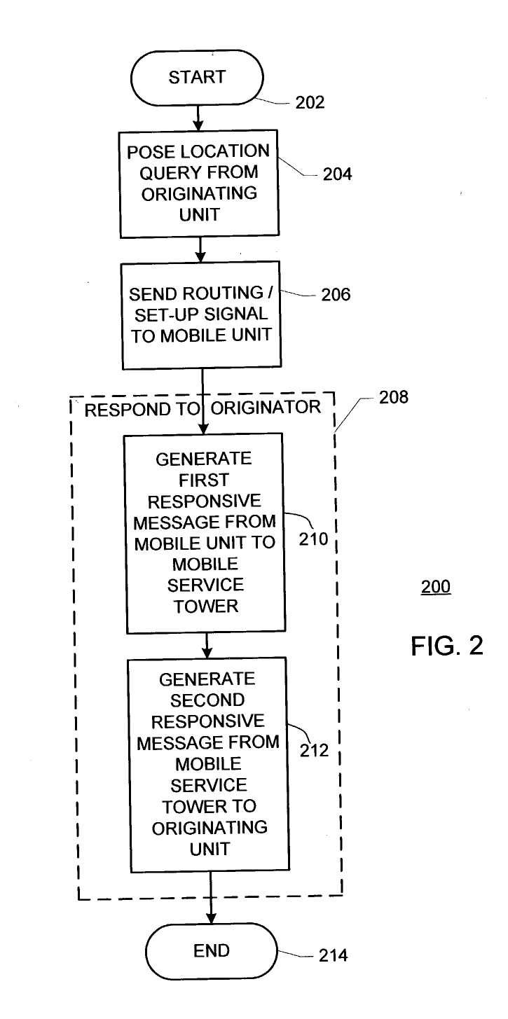

FIG. 2 is a flow diagram illustrating the method of the present invention. In FIG. 2, a method 200 for determining geographic location of a particular mobile communication unit of a plurality of communication units in a telecommunication network begins at a START locus 202. The telecommunication network includes at least one mobile service tower for establishing a wireless communication link with the particular mobile communication unit. Selected calling sessions with selected communication units of the plurality of communication units are preceded by a plurality of set-up signals for configuring the telecommunications network for supporting the selected calling sessions.

Method 200 continues by posing a location query from an originating calling unit in communication with the telecommunication network, as indicated by a block 204. The location query specifies the particular mobile communication unit. Method 200 continues by routing at least one set-up signal of the plurality of set-up signals to the particular mobile communication unit in response to the location query to alert the particular mobile communication signal of the posing, as indicated by a block 206.

Method 200 continues by sending at least one response signal from the particular mobile communication unit to the originating calling unit identifying a respective serving mobile service tower of the at least one mobile service tower in wireless communication with the particular mobile communication unit, as indicated by a block 208. The response signal may be configured as a first responsive message from the mobile unit to the mobile service tower (or to the mobile switching center), as indicated by a block 210, and a second responsive message from the mobile service tower (or from the mobile switching center) to the originating unit, as indicated by a block 212. Method 200 thereafter terminates, as indicated by a block 214, until another location query is posed.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. A method for determining geographic location of a particular mobile communication unit served by a telecommunication network; said telecommunication network effecting communication calling among selected communication units of a plurality of communication units in a plurality of calling sessions; said plurality of communication units including a plurality of mobile units and a plurality of wireline units; said telecommunication network configuring for supporting a respective said calling session of said plurality of calling sessions using a plurality of routing signals; said telecommunication network including at least one mobile switching facility; each respective mobile switching facility of said at least one mobile switching facility operating with at least one mobile service access point for effecting wireless communication with selected mobile units of said plurality of mobile units; the method comprising the steps of:
(a) posing a location query from an originating communication unit of said plurality of communication units; said location query specifying said particular mobile communication unit;
(b) sending at least one routing signal of said plurality of routing signals via at least one serving mobile service access point of said at least one mobile service access point to said particular mobile communication unit for alerting said particular mobile communication unit of said posing;
(c) generating a first responsive message from said particular mobile communication unit to said at least one serving mobile service access point to acknowledge receiving said at least one routing signal alert; and
(d) generating a second responsive message from said at least one serving mobile service access point to said originating communication unit; said second responsive message identifying said at least one serving mobile service access point.

2. A method for determining geographic location of a particular mobile communication unit served by a telecommunication network as recited in claim 1 wherein said at least one serving mobile service access point communicates with selected said mobile units in a plurality of sectors arrayed about each respective said at least one serving mobile service access point, and wherein said second responsive message includes an indication of which sector of said plurality of sectors contains said particular mobile communication unit.

3. A method for determining geographic location of a particular mobile communication unit served by a telecommunication network as recited in claim 1 wherein no other routing signal than said at least one routing signal is sent to said particular mobile communication unit.

4. A method for determining geographic location of a particular mobile communication unit served by a telecommunication network as recited in claim 1 wherein each respective mobile unit of said plurality of mobile units is identified by a respective identifying code, and wherein said specifying said particular mobile communication unit is effected by including said respective identifying code for said particular mobile communication unit in said location query.

5. A method for determining geographic location of a particular mobile communication unit served by a telecommunication network as recited in claim 2 wherein no other routing signal than said at least one routing signal is sent to said particular mobile communication unit.

6. A method for determining geographic location of a particular mobile communication unit served by a telecommunication network as recited in claim 2 wherein each respective mobile unit of said plurality of mobile units is identified by a respective identifying code, and wherein said specifying said particular mobile communication unit is effected by including said respective identifying code for said particular mobile communication unit in said location query.

7. A method for determining geographic location of a particular mobile communication unit served by a telecommunication network as recited in claim 6 wherein no other routing signal than said at least one routing signal is sent to said particular mobile communication unit.

8. A method for determining geographic location of a particular mobile communication unit of a plurality of communication units in a telecommunication network; said telecommunication network including at least one mobile service access point for establishing a wireless communication link with said particular mobile communication unit; selected calling sessions with selected communication units of said plurality of communication units being preceded by a plurality of set-up signals for configuring said telecommunications network for supporting said selected calling sessions; the method comprising the steps of:
(a) posing a location query from an originating calling unit in communication with said telecommunication network; said location query specifying said particular mobile communication unit;
(b) in response to said location query routing at least one set-up signal of said plurality of set-up signals to said particular mobile communication unit to alert said particular mobile communication signal of said posing;
(c) sending at least one response signal from said particular mobile communication unit to said originating calling unit identifying a respective serving mobile service access point of said at least one mobile service access point in wireless communication with said particular mobile communication unit.

9. A method for determining geographic location of a particular mobile communication unit of a plurality of communication units in a telecommunication network as recited in claim 8 wherein said respective serving mobile service access point establishes wireless communications in a plurality of sectors arrayed about said respective serving mobile service access point, and wherein said at least one response signal includes an indication of which sector of said plurality of sectors contains said particular mobile communication unit.

10. A method for determining geographic location of a particular mobile communication unit of a plurality of communication units in a telecommunication network as recited in claim 8 wherein no other set-up signal than said at least one set-up signal is routed to said particular mobile communication unit.

11. A method for determining geographic location of a particular mobile communication unit of a plurality of communication units in a telecommunication network as recited in claim 8 wherein each respective communication unit of said plurality of communication units is identified by a respective identifying code, and wherein said specifying said particular mobile communication unit is effected by including said respective identifying code for said particular mobile communication unit in said location query.

12. A method for determining geographic location of a particular mobile communication unit of a plurality of communication units in a telecommunication network as recited in claim 9 wherein no other set-up signal than said at least one set-up signal is routed to said particular mobile communication unit.

13. A method for determining geographic location of a particular mobile communication unit of a plurality of communication units in a telecommunication network as recited in claim 9 wherein each respective communication unit of said plurality of communication units is identified by a respective identifying code, and wherein said specifying said particular mobile communication unit is effected by including said respective identifying code for said particular mobile communication unit in said location query.

14. A method for determining geographic location of a particular mobile communication unit of a plurality of communication units in a telecommunication network as recited in claim 13 wherein no other set-up signal than said at least one set-up signal is routed to said particular mobile communication unit.

15. A system for determining geographic location of a particular mobile communication unit of a plurality of communication units in a telecommunication network; said telecommunication network including at least one mobile service access point for establishing a wireless communication link with said particular mobile communication unit; said establishing said wireless communication link including a plurality of set-up signals for configuring said telecommunications network for supporting said wireless communication link; the system comprising:
(a) means for posing a location query from an originating calling unit in communication with said telecommunication network; said location query specifying said particular mobile communication unit;
(b) means for routing at least one set-up signal of said plurality of set-up signals to said particular mobile communication unit in response to said location query to alert said particular mobile communication signal of said posing;
(c) means for sending at least one response signal from said particular mobile communication unit to said originating calling unit identifying a respective serving mobile service access point of said at least one mobile service access point in wireless communication with said particular mobile communication unit.

16. A system for determining geographic location of a particular mobile communication unit of a plurality of communication units in a telecommunication network as recited in claim 15 wherein said respective serving mobile service access point establishes wireless communications in a plurality of sectors arrayed about said respective serving mobile service access point, and wherein said at least one response signal includes an indication of which sector of said plurality of sectors contains said particular mobile communication unit.

17. A system for determining geographic location of a particular mobile communication unit of a plurality of communication units in a telecommunication network as recited in claim 15 wherein no other set-up signal than said at least one set-up signal is routed to said particular mobile communication unit.

18. A system for determining geographic location of a particular mobile communication unit of a plurality of communication units in a telecommunication network as recited in claim 15 wherein each respective communication unit of said plurality of communication units is identified by a respective identifying code, and wherein said specifying said particular mobile communication unit is effected by including said respective identifying code for said particular mobile communication unit in said location query.

19. A system for determining geographic location of a particular mobile communication unit of a plurality of communication units in a telecommunication network as recited in claim 16 wherein no other set-up signal than said at least one set-up signal is routed to said particular mobile communication unit.

20. A system for determining geographic location of a particular mobile communication unit of a plurality of communication units in a telecommunication network as recited in claim 16 wherein each respective communication unit of said plurality of communication units is identified by a respective identifying code, and wherein said specifying said particular mobile communication unit is effected by including said respective identifying code for said particular mobile communication unit in said location query.
